(19) United States
(12) Patent Application Publication
(10) Pub. No.: US 2026/0098108 A1
(43) Pub. Date: Apr. 9, 2026

(54) RUBBER COMPOSITION AND TIRE

(71) Applicant: Toyo Tire Corporation, Itami-shi (JP)

(72) Inventor: Yosuke Nakaji, Itami-shi (JP)

(73) Assignee: Toyo Tire Corporation, Itami-shi (JP)

(21) Appl. No.: 19/332,461

(22) Filed: Sep. 18, 2025

(30) Foreign Application Priority Data
Oct. 7, 2024 (JP) 2024-175890

(51) Int. Cl. C08F 36/06; B60C 1/00; B60C 11/00; C08K 5/053; C08K 5/103

(52) U.S. Cl. CPC C08F 36/06; B60C 1/0016; B60C 1/0025; B60C 11/0008; C08K 5/053; C08K 5/103; B60C 2011/0025

(57) ABSTRACT

A rubber composition according to an embodiment contains a diene rubber, silica, a plant-derived glyceryl oleate, and a mineral oil that is an optional component. The glyceryl oleate includes glyceryl monooleate as a part thereof. The mineral oil (including an extender oil) is contained such that the mass ratio of the mineral oil to the glyceryl oleate is 0 or more and 5.0 or less.

### BACKGROUND OF THE INVENTION

### 1. Field of the Invention

The present invention relates to a rubber composition and a tire using the same.

### 2. Description of Related Art

As plasticizers to be incorporated when making a rubber composition, generally, mineral oils such as aromatic oils, naphthenic oils, and paraffinic oils are used.

Meanwhile, it is known that a surfactant, such as a glycerin mono-fatty acid ester, is incorporated as an additive into a rubber composition. For example, JP2016-037601A discloses a rubber composition excellent in silica dispersibility and fuel economy without a decrease in the processability or hardness, which is obtained by incorporating silica, a silane coupling agent, and a glycerin mono-fatty acid ester derived from a fatty acid having 8 to 24 carbon atoms into a diene rubber having a heteroatom-containing functional group in the backbone and/or at the end.

JP2016-037602A discloses a rubber composition excellent in silica dispersibility, processability, and rolling resistance, which is obtained by incorporating a diene rubber, silica having a BET specific surface area of 200 to 400 m²/g, a silane coupling agent, and a glycerin mono-fatty acid ester derived from a fatty acid having 8 to 24 carbon atoms.

WO2015/166997A1 discloses a rubber composition for a tire, which simultaneously achieves grip performance, WET performance, and abrasion resistance and also has processability. The rubber composition contains a rubber component composed of a natural rubber and/or a diene rubber, a glycerin fatty acid ester composition containing a glycerin fatty acid monoester, and silica having a BET specific surface area of 100 to 130 m²/g.

### SUMMARY OF THE INVENTION

From the viewpoint of resource conservation, environmental friendliness, and the like, there is a demand for the development of a rubber composition in which the mineral oil incorporated as a plasticizer is partially or completely replaced with a new raw material. When considering raw materials to replace mineral oils (hereinafter sometimes referred to as “alternative raw material”), it is desirable that a rubber composition incorporating the alternative raw material has physical properties at least equivalent to those of conventional rubber compositions. In addition, if a plant-derived raw material can be used as an alternative raw material, a reduction in the use of petroleum-derived resources can also be expected. However, in the case where the mineral oil is replaced with a vegetable oil, for example, the physical properties of the resulting vulcanized rubber may be inferior.

In view of the above points, an object of an embodiment of the invention is to provide a rubber composition for a tire, which contains a plant-derived raw material capable of partially or completely replacing a mineral oil.

The invention includes the following embodiments.
[1] A rubber composition for a tire, including a diene rubber, silica, a plant-derived glyceryl oleate, and a mineral oil that is an optional component, in which the glyceryl oleate includes glyceryl monooleate, and a mass ratio of the mineral oil to the glyceryl oleate is 0 or more and 5.0 or less.
[2] The rubber composition for a tire according to [1], in which the mass ratio of the mineral oil to the glyceryl oleate is 0 or more and 1.5 or less.
[3] The rubber composition for a tire according to [1] or [2], in which 100 parts by mass of the diene rubber includes 20 to 60 parts by mass of an unmodified styrene butadiene rubber and 40 to 80 parts by mass of a modified styrene butadiene rubber.
[4] The rubber composition for a tire according to any one of [1] to [3], in which a total content of the glyceryl oleate and the mineral oil is 10 to 30 parts by mass per 100 parts by mass of the diene rubber.
[5] The rubber composition for a tire according to any one of [1] to [4], further including propylene glycol.
[6] A tire having a rubber portion made using the rubber composition according to any one of [1] to [5].

According to an embodiment of the invention, a rubber composition for a tire, which contains a plant-derived raw material capable of partially or completely replacing a mineral oil, can be provided.

### DESCRIPTION OF EMBODIMENTS

The present inventor has conducted extensive research on raw materials that function as replacements for mineral oils without impairing properties as a vulcanized rubber. As a result, the present inventor has found that when a glyceryl oleate that is a plant-derived glyceryl oleate and includes glyceryl monooleate as a part thereof is used to partially or completely replace a mineral oil, the 300% modulus of the resulting vulcanized rubber is improved while reducing the use of petroleum-derived resources. In a glyceryl oleate including glyceryl monooleate, the unsaturated bond in oleic acid has high compatibility with rubber, and also the affinity for silica increases due to the hydroxyl group of the glycerin skeleton. Therefore, such a glyceryl oleate is believed to function as a replacement for a mineral oil and also provide a vulcanized rubber with improved physical properties.

A rubber composition according to this embodiment contains a diene rubber as a rubber component, silica as a reinforcing filler, and, as a plasticizer, a glyceryl oleate including glyceryl monooleate and a mineral oil. Here, the mineral oil is an optional component, and therefore the rubber composition according to this embodiment may or may not contain a mineral oil.

In this embodiment, a diene rubber refers to a rubber with a repeating unit corresponding to a diene monomer having a conjugated double bond, and contains a carbon-carbon double bond in the polymer backbone. Specific examples of diene rubbers include various diene rubbers commonly used in rubber compositions, such as natural rubber (NR), synthetic isoprene rubber (IR), polybutadiene rubber (BR), styrene butadiene rubber (SBR), nitrile rubber (NBR), chloroprene rubber (CR), styrene-isoprene copolymer rubber, butadiene-isoprene copolymer rubber, and styrene-isoprene-butadiene copolymer rubber. As these diene rubbers, the concept thereof also encompasses those modified at the ends or in the backbone as necessary and those reformed to impart desired properties. These diene rubbers may be used alone, and it is also possible to use two or more kinds together.

As the diene rubber, an oil-extended diene rubber may also be used. As extender oils used for oil-extending a diene rubber, mineral oils such as aromatic oils, naphthenic oils, and paraffinic oils can be mentioned, for example.

In one embodiment, the diene rubber may include a styrene butadiene rubber (SBR). The SBR may be a solution-polymerized styrene butadiene rubber (SSBR) or an emulsion-polymerized styrene butadiene rubber (ESBR). In addition, The SBR may be a modified styrene butadiene rubber (modified SBR), an unmodified styrene butadiene rubber (unmodified SBR), or a combination thereof.

Preferably, in one embodiment, the diene rubber includes a modified styrene butadiene rubber (modified SBR). As the modified SBR, one that has a functional group introduced into its end and/or backbone and thus has been modified with the functional group is used. The functional group preferably contains an oxygen atom and/or a nitrogen atom and, for example, at least one selected from the group consisting of an amino group, a hydroxy group, an alkoxy group, an alkoxysilyl group, an epoxy group, and a carboxy group can be mentioned.

The modified styrene butadiene rubber (modified SBR) may be a modified solution-polymerized styrene butadiene rubber (modified SSBR), a modified emulsion-polymerized styrene butadiene rubber (modified ESBR), or a combination thereof. The amount of modified SBR in 100 parts by mass of the diene rubber is not particularly limited, and may be, for example, 30 parts by mass or more, 40 parts by mass or more, or 50 parts by mass or more.

In one embodiment, the diene rubber may be a combination of an unmodified SBR and a modified SBR, and it is preferable to use an unmodified ESBR and a modified SSBR. For example, 100 parts by mass of the diene rubber may include 20 to 60 parts by mass, more preferably 30 to 50 parts by mass, of an unmodified SBR (preferably an unmodified ESBR) and 40 to 80 parts by mass, more preferably 50 to 70 parts by mass, of a modified SBR (preferably a modified SSBR).

In this embodiment, examples of silica include wet silica and dry silica. It is preferable to use wet silica such as precipitated silica or gelled silica.

The BET specific surface area of silica is not particularly limited, and may be 100 to 300 m²/g, for example, and is more preferably 150 to 250 m²/g. Here, the BET specific surface area of silica is measured in accordance with the BET method described in JIS K6430:2008.

The amount of silica per 100 parts by mass of the diene rubber is preferably 30 to 150 parts by mass, more preferably 50 to 120 parts by mass, still more preferably 60 to 110 parts by mass, and yet more preferably 70 to 100 parts by mass.

The rubber composition according to this embodiment incorporates a plant-derived glyceryl oleate that includes glyceryl monooleate as a part thereof. A glyceryl oleate is an ester of oleic acid and glycerin (glycerin fatty acid ester), and the term is used as a concept including glyceryl monooleate, glyceryl dioleate, and glyceryl trioleate. The plant-derived glyceryl oleate may be one synthesized from plant-derived oleic acid and plant-derived glycerin.

As components present in the plant-derived glyceryl oleate, glyceryl dioleate and/or glyceryl trioleate may be present together with glyceryl monooleate, or it is also possible that only glyceryl monooleate is present. The glyceryl monooleate content in the glyceryl oleate is not particularly limited, and may be, for example, 30 to 80%, 40 to 70%, or 50 to 60%. The content (%) of each component in the glyceryl oleate can be determined by high performance liquid chromatography (GPC) measurement. In detail, for example, from the value of the peak area of the glyceryl monooleate component in the total peak area obtained by GPC measurement, the glyceryl monooleate content (%) is calculated as the area percentage.

The rubber composition according to this embodiment may incorporate propylene glycol together with the plant-derived glyceryl oleate. The amount of propylene glycol incorporated is not particularly limited, and may be, for example, 20 parts by mass or less, or 5 to 15 parts by mass, per 100 parts by mass of glyceryl oleate.

The rubber composition according to this embodiment may optionally contain a mineral oil. As mineral oils, for example, aromatic oils, naphthenic oils, and paraffinic oils can be mentioned. They may be used alone, and it is also possible to use two or more kinds together.

In this embodiment, the mineral oil is contained such that the mass ratio of the mineral oil to the glyceryl oleate (mineral oil/glyceryl oleate) is 0 or more and 5.0 or less. Incidentally, in the case where an oil-extended rubber is used as the diene rubber, the mass of the mineral oil also includes the mass of the mineral oil contained in the oil-extended rubber (extender oil). The mass ratio (mineral oil/glyceryl oleate) is preferably 0 to 3.0, more preferably 0 to 1.5, still more preferably 0 or more and less than 1.0, and yet more preferably 0 to 0.8.

The content of the plasticizer as a whole (the sum of the glyceryl oleate and the mineral oil) in the rubber composition is not particularly limited, and may be, for example, 10 to 100 parts by mass, 15 to 50 parts by mass, 20 to 40 parts by mass, or 20 to 30 parts by mass per 100 parts by mass of the diene rubber. The content of the glyceryl oleate is not particularly limited, and may be, for example, 3 to 50 parts by mass, 5 to 45 parts by mass, 7 to 40 parts by mass, or 10 to 30 parts by mass per 100 parts by mass of the diene rubber. The content of the mineral oil is not particularly limited, and may be, for example, 0 to 50 parts by mass, 1 to 40 parts by mass, 3 to 30 parts by mass, or 5 to 20 parts by mass per 100 parts by mass of the diene rubber.

In addition to the above components, the rubber composition according to this embodiment can also incorporate various additives that are generally used in rubber compositions, such as carbon black, silane coupling agents, stearic acid, zinc oxide, waxes, antioxidants, vulcanizing agents, and vulcanization accelerators.

The amount of carbon black incorporated is not particularly limited, but is preferably 0 to 30 parts by mass, more preferably 0 to 20 parts by mass, and still more preferably 3 to 15 parts by mass, and may also be 3 to 10 parts by mass, per 100 parts by mass of the diene rubber.

As silane coupling agents, for example, a sulfide silane coupling agent, a mercapto silane coupling agent, and a thioester group-containing silane coupling agent can be mentioned. The silane coupling agent content is not particularly limited, and may be, for example, 5 to 20 parts by mass, or 5 to 15 parts by mass, per 100 parts by mass of silica.

The stearic acid content is not particularly limited, and may be, for example, 0 to 10 parts by mass, 0.5 to 5 parts by mass, or 1 to 4 parts by mass per 100 parts by mass of the diene rubber.

The zinc oxide content is not particularly limited, and may be, for example, 0 to 10 parts by mass, 0.5 to 5 parts by mass, or 1 to 4 parts by mass per 100 parts by mass of the diene rubber.

The wax content is not particularly limited, and may be, for example, 0 to 10 parts by mass, 0.5 to 5 parts by mass, or 1 to 4 parts by mass per 100 parts by mass of the diene rubber.

As antioxidants, for example, amine-ketone-based, aromatic secondary amine-based, monophenol-based, bisphenol-based, benzimidazole-based, and like various antioxidants can be mentioned. Any one of them, or a combination of two or more, can be used. The antioxidant content is not particularly limited, and may be, for example, 0 to 10 parts by mass, 0.5 to 5 parts by mass, or 1 to 4 parts by mass per 100 parts by mass of the diene rubber.

Sulfur is preferably used as a vulcanizing agent. The vulcanizing agent content is not particularly limited, and may be, for example, 0.1 to 10 parts by mass, 0.5 to 5 parts by mass, or 1 to 3 parts by mass per 100 parts by mass of the diene rubber.

As vulcanization accelerators, for example, sulfenamide-based, guanidine-based, thiuram-based, thiazole-based, and like various vulcanization accelerators can be mentioned. Any one of them, or a combination of two or more, can be used. The vulcanization accelerator content is not particularly limited, and may be, for example, 0.1 to 10 parts by mass, 1 to 7 parts by mass, or 2 to 5 parts by mass per 100 parts by mass of the diene rubber.

The rubber composition according to this embodiment can be made by kneading in the usual manner using a commonly used mixing machine, such as a Banbury mixer, a kneader, or a roll. That is, for example, in the first mixing stage, additives other than a vulcanizing agent and a vulcanization accelerator are added to a diene rubber and mixed. Next, in the final mixing stage, a vulcanizing agent and a vulcanization accelerator are added to the obtained mixture, whereby a rubber composition can be prepared. Prior to the final mixing stage, the mixture obtained in the first mixing stage may be kneaded again.

The rubber composition according to this embodiment can be used in various sections of a tire, such as treads, sidewalls, and bead parts of pneumatic tires of various sizes for various applications, including tires for passenger cars, large-size tires for trucks and buses, and the like. Use in the tread or sidewall of a tire is preferable. That is, a tire according to one embodiment has a rubber portion made using the rubber composition described above.

In one embodiment, the method for producing a tire including a rubber portion made using the rubber composition described above is not particularly limited. For example, the rubber composition is molded into a predetermined shape by extrusion in the usual manner to give an unvulcanized rubber member (e.g., tread rubber, sidewall rubber, etc.). The rubber member is combined with other tire members to make an unvulcanized tire (green tire). Subsequently, vulcanization molding is performed at 140 to 180° C., for example, whereby a tire can be produced.

### EXAMPLES

Hereinafter, examples of the invention will be shown, but the invention is not limited to these examples.

The raw materials used in the examples and comparative examples are as follows.
SBR-1: Unmodified ESBR, “SBR 1502” manufactured by ENEOS Materials Corporation
SBR-2: SSBR terminally modified with alkoxysilyl and amino groups, “HPR 350” manufactured by ENEOS Materials Corporation
Carbon black: HAF, “N339 SEAST KH” manufactured by Tokai Carbon Co., Ltd.
Silica: “Nipsil AQ” manufactured by Tosoh Silica Corporation (BET specific surface area=205 m²/g)
Silane coupling agent: “Si69” manufactured by Evonik
Aromatic oil: “PROCESS NC140” manufactured by ENEOS Corporation
Glyceryl oleate: “RHEODOL MO-60” manufactured by Kao Corporation, plant-derived glyceryl oleate (glyceryl monooleate content in glyceryl oleate=48 to 58%), glyceryl oleate/propylene glycol=89/11 (mass %)
Stearic acid: “LUNAC S-20” manufactured by Kao Corporation
Zinc oxide: “Zinc Oxide, Type 2” manufactured by Mitsui Mining & Smelting Co., Ltd.
Wax: “OZOACE 0355” manufactured by Nippon Seiro Co., Ltd.
Antioxidant-1: N-(1,3-dimethylbutyl)-N′-phenyl-p-phenylenediamine, “NOCRAC 6C” manufactured by Ouchi Shinko Chemical Industrial Co., Ltd.
Antioxidant-2: Poly(2,2,4-trimethyl-1,2-dihydroquinoline), “ANTAGE RD” manufactured by Kawaguchi Chemical Industry Co., Ltd.
Vulcanization accelerator-1: “SOXINOL CZ” manufactured by Sumitomo Chemical Co., Ltd.
Vulcanization accelerator-2: Diphenyl guanidine, “NOCCELER D” manufactured by Ouchi Shinko Chemical Industrial Co., Ltd.
Vulcanizing agent: “Powder Sulfur” manufactured by Tsurumi Chemical Industry Co., Ltd.

The 300% modulus evaluation method in the examples and comparative examples is as follows.

In accordance with JIS K6251:2017, a tensile test (No. 3 dumbbell shape) was performed to measure the 300% modulus (stress at 300% elongation). In Table 1, the values of the comparative examples and examples are each shown as an index taking the value of Comparative Example 1 as 100. A larger index indicates a higher 300% modulus. The higher the 300% modulus, the higher the tire rigidity, indicating better steering stability.

According to the formulation (parts by mass) shown in Table 1 below, a rubber composition was prepared using a Banbury mixer. In detail, first, in the first mixing stage, all ingredients excluding a vulcanizing agent and a vulcanization accelerator were added to a diene rubber together with silica, a glyceryl oleate, and a mineral oil as an optional component, and kneaded (discharge temperature=160° C.). The discharged rubber composition was fed to a Banbury mixer and kneaded again, and then discharged (discharge temperature=160° C.). Next, in the final mixing stage, a vulcanizing agent and a vulcanization accelerator were added to the obtained kneaded product and kneaded (discharge temperature=100° C.) to prepare a rubber composition.

Each obtained rubber composition was vulcanized at 160° C. for 20 minutes to make a rubber sample, and the 300% modulus was evaluated.

The results are as shown in Table 1 below. In the glyceryl oleate section of the table, the numbers in parentheses indicate the parts by mass of the glyceryl oleate contained in “RHEODOL MO-60”, excluding the mass of propylene glycol. In addition, Plasticizer Component Mass Ratio in the table means the mass ratio of the aromatic oil to the glyceryl oleate (hereinafter sometimes simply referred to as “plasticizer component mass ratio”). In Table 1, only the plasticizer component mass ratio was changed, and the obtained rubber compositions were evaluated.

Comparative Example 1 is an example where only an aromatic oil was used as a plasticizer, and Comparative Example 2 is an example where a plasticizer was incorporated such that the plasticizer component mass ratio was 10.1. In Comparative Example 2, although an improvement in the 300% modulus over Comparative Example 1 was seen, the extent thereof was small.

Examples 1 to 5 are examples where the plasticizer component mass ratios were set to 4.5, 2.6, 1.1, 0.55, and 0, respectively. In all of the examples, as compared to Comparative Example 1, the 300% modulus clearly improved. In addition, as the plasticizer component mass ratio approached 0, that is, as the proportion of the glyceryl oleate incorporated increased, a significant improvement in the 300% modulus was seen.

TABLE 1

| | Comp. | Comp. | | | | | |
|---|---|---|---|---|---|---|---|
| | Ex. 1 | Ex. 2 | Ex. 1 | Ex. 2 | Ex. 3 | Ex. 4 | Ex. 5 |
| Formulation (parts by mass) | | | | | | | |
| SBR-1 | 40 | 40 | 40 | 40 | 40 | 40 | 40 |
| SBR-2 | 60 | 60 | 60 | 60 | 60 | 60 | 60 |
| Carbon black | 5 | 5 | 5 | 5 | 5 | 5 | 5 |
| Silica | 85 | 85 | 85 | 85 | 85 | 85 | 85 |
| Silane coupling agent | 7 | 7 | 7 | 7 | 7 | 7 | 7 |
| Aromatic oil | 27.0 | 24.3 | 21.6 | 18.9 | 13.5 | 8.9 | |
| Glyceryl oleate | | 2.7 | 5.4 | 8.1 | 13.5 | 18.1 | 27.0 |
| | | (2.4) | (4.8) | (7.2) | (12.0) | (16.1) | (24.0) |
| Stearic acid | 2 | 2 | 2 | 2 | 2 | 2 | 2 |
| Zinc oxide | 2 | 2 | 2 | 2 | 2 | 2 | 2 |
| Wax | 2 | 2 | 2 | 2 | 2 | 2 | 2 |
| Antioxidant-1 | 2 | 2 | 2 | 2 | 2 | 2 | 2 |
| Antioxidant-2 | 1 | 1 | 1 | 1 | 1 | 1 | 1 |
| Vulcanization accelerator-1 | 2 | 2 | 2 | 2 | 2 | 2 | 2 |
| Vulcanization accelerator-2 | 2 | 2 | 2 | 2 | 2 | 2 | 2 |
| Vulcanizing agent | 2 | 2 | 2 | 2 | 2 | 2 | 2 |
| Plasticizer Component | | 10.1 | 4.5 | 2.6 | 1.1 | 0.55 | 0 |
| Mass Ratio | | | | | | | |
| Evaluation (index) | | | | | | | |
| 300% Modulus | 100 | 102 | 104 | 105 | 109 | 113 | 118 |

Incidentally, with respect to the various numerical ranges described herein, the upper and lower limits thereof can be arbitrarily combined, and all such combinations are incorporated herein as preferred numerical ranges. In addition, the description of a numerical range “X to Y” means X or more and Y or less.

Although some embodiments of the invention have been described above, these embodiments are presented as examples and not intended to limit the scope of the invention. These embodiments can be implemented in other various modes, and various omissions, substitutions, and changes can be made thereto without departing from the gist of the invention. These embodiments, as well as omissions, substitutions, and changes thereto, etc., fall within the scope and gist of the invention, and also fall within the scope of the claimed invention and its equivalents.

What is claimed is:

1. A rubber composition for a tire, comprising a diene rubber, silica, a plant-derived glyceryl oleate, and a mineral oil that is an optional component, wherein
the glyceryl oleate includes glyceryl monooleate, and
a mass ratio of the mineral oil to the glyceryl oleate is 0 or more and 5.0 or less.

2. The rubber composition for a tire according to claim 1, wherein the mass ratio of the mineral oil to the glyceryl oleate is 0 or more and 1.5 or less.

3. The rubber composition for a tire according to claim 1, wherein 100 parts by mass of the diene rubber includes 20 to 60 parts by mass of an unmodified styrene butadiene rubber and 40 to 80 parts by mass of a modified styrene butadiene rubber.

4. The rubber composition for a tire according to claim 1, wherein a total content of the glyceryl oleate and the mineral oil is 10 to 30 parts by mass per 100 parts by mass of the diene rubber.

5. The rubber composition for a tire according to claim 1, further comprising propylene glycol.

6. A tire having a rubber portion made using the rubber composition according to claim 1.
